(19) United States
(12) Patent Application Publication
(10) Pub. No.: US 2010/0251521 A1
(43) Pub. Date: Oct. 7, 2010

(54) DOOR HINGE ASSEMBLY

(75) Inventor: Joseph A. Donoho, Springfield, TN (US)

Correspondence Address: PEARNE & GORDON LLP, 1801 EAST 9TH STREET, SUITE 1200, CLEVELAND, OH, 44114-3108, US

(73) Assignee: Electrolux Home Products, Inc., Cleveland, OH (US)

(21) Appl. No.: 12/416,243

(22) Filed: Apr. 1, 2009

(51) Int. Cl. E05D 11/10

(52) U.S. Cl. 16/343

(57) ABSTRACT

A hinge assembly for a door enclosing a compartment includes a first housing, a second housing, a mounting member, a link member, a locking member, and a biasing member. The first housing includes an opening in a front wall leading to a channel. An upper stop and a lower stop are located in the channel. The mounting member includes a distal end including a first abutting portion, a second abutting portion and a slot. The distal end of the mounting member is configured to be inserted in the opening so that the first abutting portion engages the upper stop, the second abutting portion engages the lower stop and the slot engages a lower edge of the opening.

### FIELD OF THE INVENTION

The present invention relates generally to hinge assemblies, and more particularly, to hinge assemblies for appliance doors.

### BACKGROUND OF THE INVENTION

Hinge assemblies for doors in appliances such as ovens have various structures the differences of which can result in a number of advantages and drawbacks in terms of operability, reliability, durability, feel, etc. For example, a door may provide an intermediate position between a fully closed position and a fully opened position that may be helpful when using the appliance. However, such a door may also encounter problems when transitioning between multiple positions in that the movement may not be smooth and may require more force than desired. Also, a hinge assembly structure provided to overcome the former problem may not maintain the intermediate position as intended. Thus, there is a need to provide a hinge assembly structure that is an improvement over the existing structures while providing a solution to known problems.

### BRIEF SUMMARY OF THE INVENTION

Accordingly to one aspect of the present invention a hinge assembly for a door enclosing a compartment includes: a first housing configured to be mounted in the compartment and including a front wall and two adjacent side walls extending therefrom defining a channel, the front wall including an opening leading to the channel, the opening partially defined by a lower edge, an upper stop and a lower stop extending between the side walls in the channel, the upper stop located higher in the channel than the lower stop, the lower stop located closer to the front wall than the upper stop; a second housing configured to be mounted in the door; and a mounting member including a distal end and a proximal end, the proximal end of the mounting member pivotally coupled to the second housing, the distal end of the mounting member including a first abutting portion, a second abutting portion and a slot, the distal end of the mounting member configured to be inserted in the opening so that the first abutting portion engages the upper stop, the second abutting portion engages the lower stop and the slot engages the lower edge.

In accordance with another aspect of the present invention, a hinge assembly for a door enclosing a compartment includes: a first housing configured to be mounted in a compartment, the first housing including a first opening; a second housing configured to be mounted in a door, the second opening including a front wall and two adjacent side walls extending therefrom defining a channel, the second housing further including a second opening on the front wall; a mounting member including a distal end, a proximal end, and a proximal intermediate point, the distal end configured to be inserted into the first opening and engage the first housing, and the mounting member pivotally coupled to the second housing at the proximal end and projecting out of the channel through the second opening; and a link member including a first end and a second end, the first end pivotally coupled to the proximal intermediate point, a shaft through the second end configured to slide along a predetermined path between the side walls, wherein the predetermined path is delineated by a pair of grooves formed on each of the side walls.

### BRIEF DESCRIPTION OF THE DRAWINGS

FIG. 1A is a side view of an example of a hinge assembly in a closed position in accordance with the present invention.

FIG. 1B is a side view of the hinge assembly in a partially opened position.

FIG. 1C is a side view of the hinge assembly in a fully opened position.

FIG. 2 is an exploded view of the hinge assembly.

FIG. 3 is a perspective view of a second housing.

FIG. 4 is a perspective view of a first housing.

FIG. 5 is a perspective view of a cam bracket.

FIG. 6 is a side view of a mounting member.

FIG. 7 is a view of an appliance in which the hinge assembly can be mounted.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices.

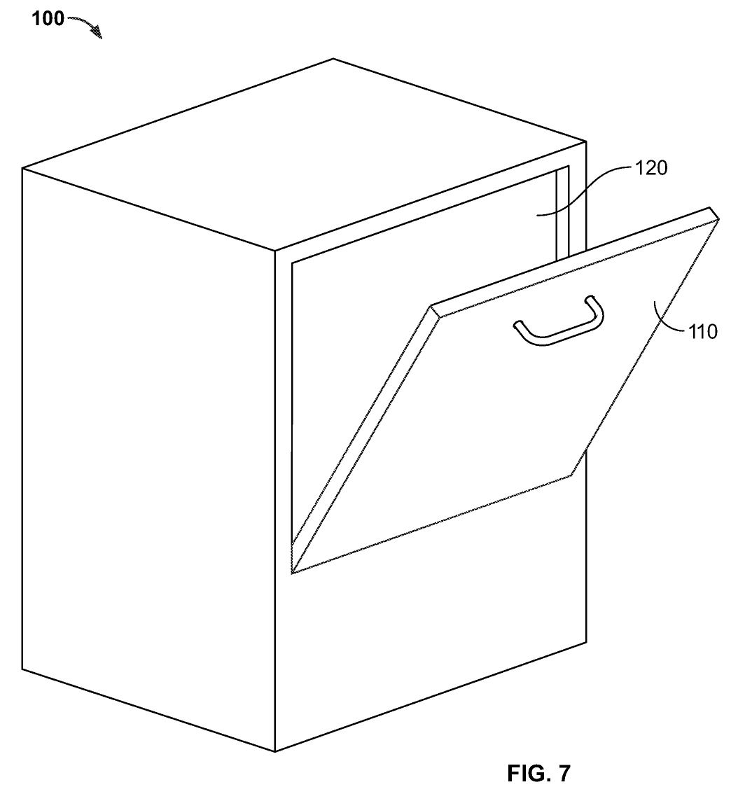

FIG. 7 shows an example of an appliance 100 in which a hinge assembly of the present invention can be implemented. The type of appliance 100 shown is an oven but the present invention may be applicable to any device with a compartment that is enclosed by a door 110 such as a dishwasher, a furnace, a rotisserie, a kiln, or the like. In such appliances, the door 110 is generally mounted adjacent the compartment using a pair of hinge assemblies on each side of the bottom of the door 110 so that the door 110 is rotated upward for closing and rotated downward for opening.

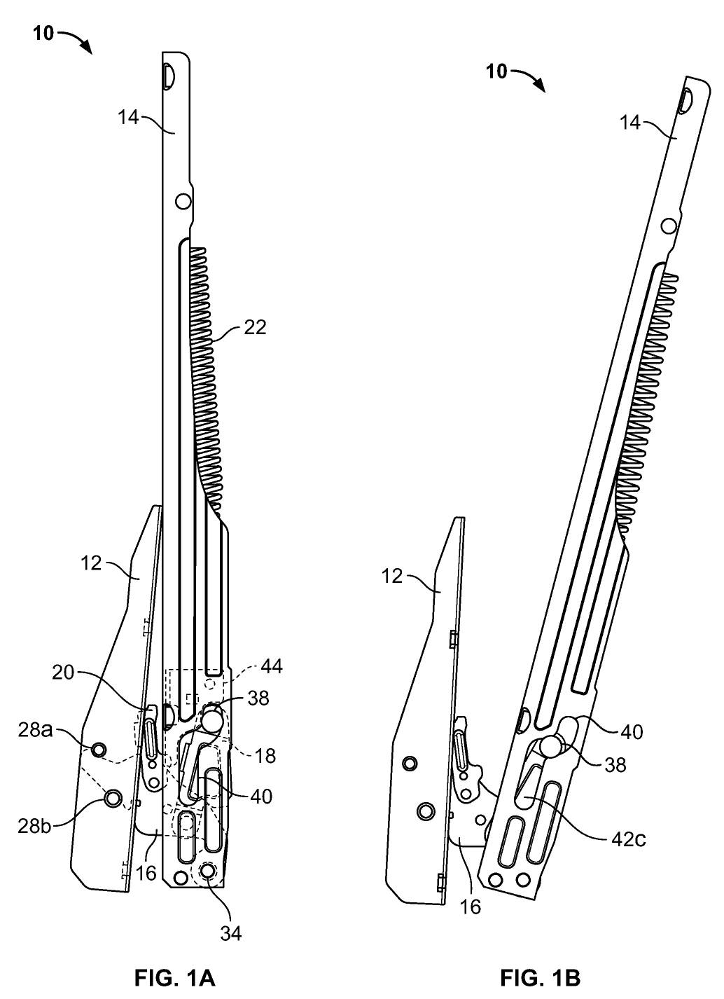

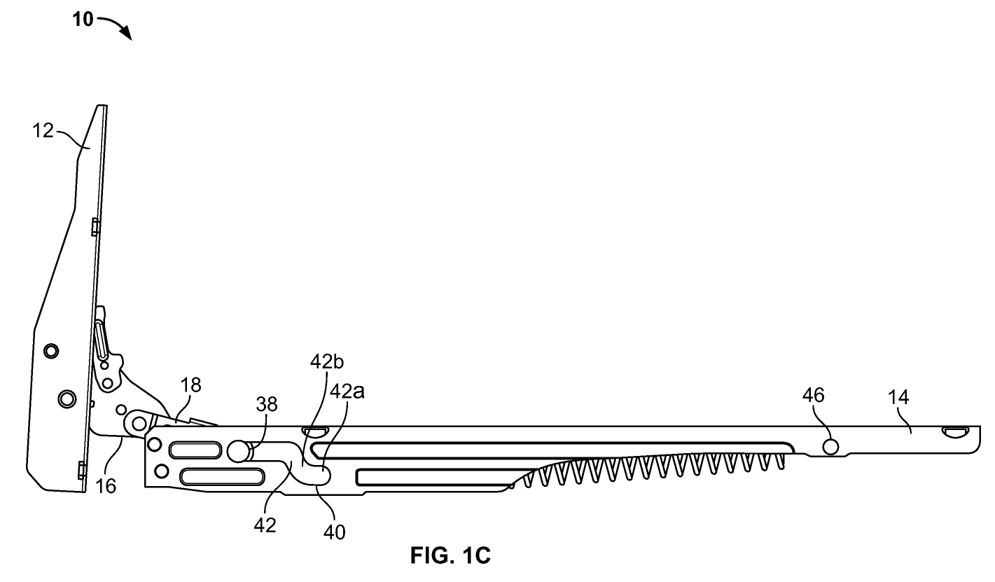

FIG. 1 shows an example embodiment of the hinge assembly 10 which may include a first housing 12, a second housing 14, a mounting member 16, a link member 18, a locking member 20, and a biasing element 22.

The first housing 12 is a part that is secured inside the body of the appliance 100 and receives the portion of the hinge assembly 10 that is located on the door 110. The first housing 12 is mounted in an upright position adjacent an opening of the compartment. As shown in FIG. 4, the first housing 12 includes a front wall 12a and two side walls 12b that extend from the front wall 12a into the appliance 100. These walls 12a, 12b combine to form a channel 24 that extends along the longitudinal length of the first housing 12. The front wall 12a also includes an elongate first opening 26 and apertures that accept fastening means such as screws, nuts-and-bolts, or the like to secure the first housing 12 to the appliance 100. The first opening 26 includes a top portion 26a that has an upper edge 26c and is rectangular and a bottom portion 26b that tapers toward a lower edge 26d of the first opening 26. In this embodiment, the side walls 12b have a substantially trapezoidal shape although other shapes may also be contemplated. The first housing 12 also includes an upper stop 28a and a lower stop 28b that extend transversely between the side walls 12b. The stops 28a, 28b may be formed through any means known in the art and in this embodiment are formed from pins or rivets which are inserted through apertures on one side wall and are secured to the first housing 12 through deformation on the other side wall. The upper stop 28a is located higher in the channel 24 than the lower stop 28b. The lower stop 28b is located closer to the front wall 12a than the upper stop 28a. The stops 28a, 28b have a round cross-section in this embodiment but other cross-sectional shapes are also contemplated. Moreover, the cross-sectional area of the upper stop 28a may differ from that of the lower stop 28b in size and shape.

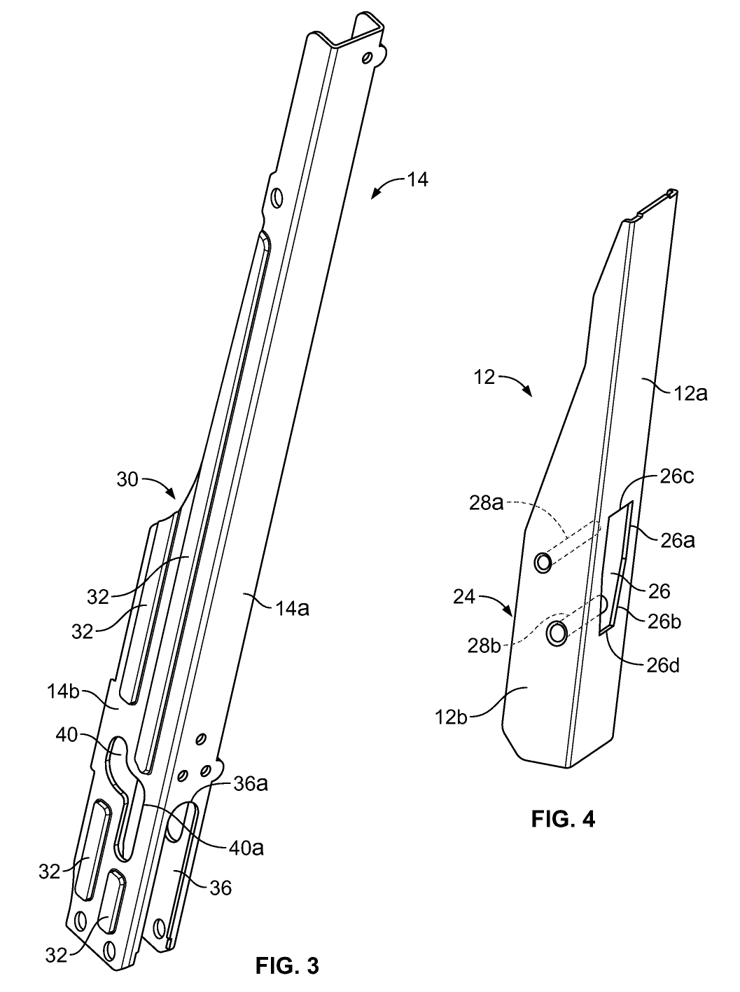

The second housing 14 is a part that is secured inside the door 110 of the appliance 100 and may house a majority of the parts in this assembly. The second housing 14 is mounted in an upright position matching the orientation of the first housing 12. In this embodiment, the second housing 14 at least partially houses the biasing element 22, the link member 18 and the mounting member 16. As shown in FIG. 3, the second housing 14 may include a front wall 14a and two side walls 14b extending therefrom into the door 110 and may thereby form a channel 30 that extends along the length of the second housing 14 similar to the channel 24 of the first housing 12. The walls 14b may be configured with apertures to accommodate fastening means such as screws, nuts-and-bolts, or the like to secure the second housing 14 to the door 110. The walls 14a, 14b may also be configured with elongate beads or raised portions 32 for purposes of reinforcement. The side walls 14b may include transversely extending bars, shafts or pins by which some parts of the hinge assembly 10 are secured or pivotally coupled to the second housing 14 in order to structurally reinforce the second housing 14 and guard against deformation from repeated loading.

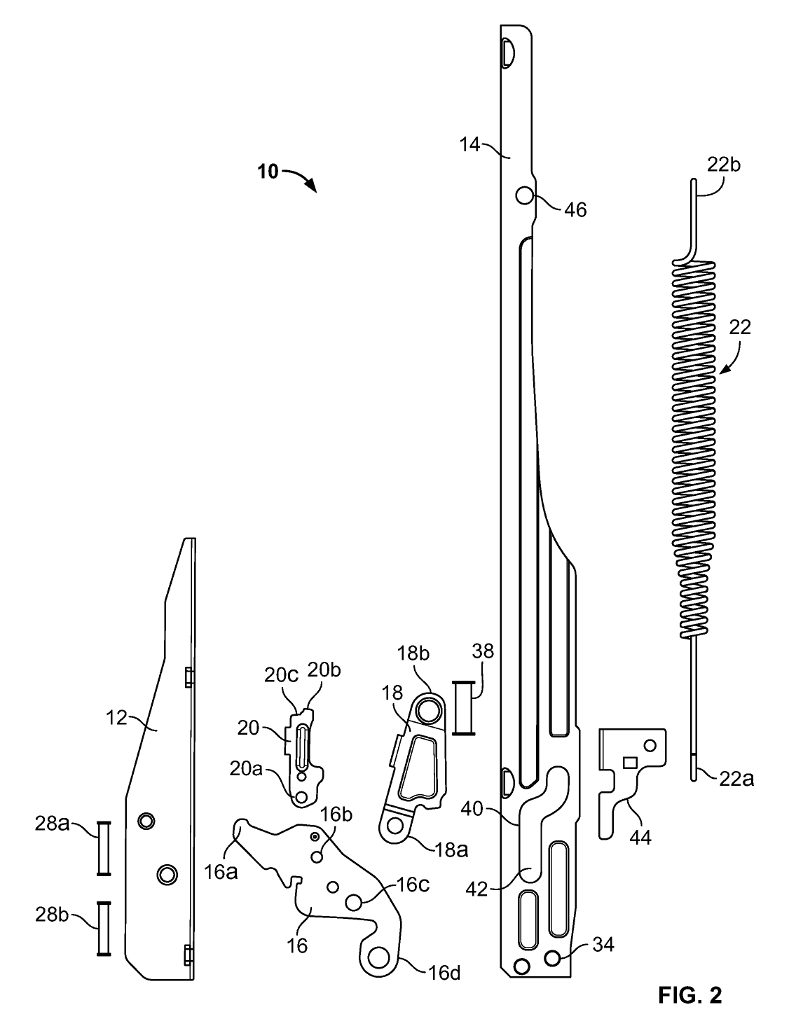

As shown in FIG. 6, the mounting member 16 may be a claw-like plate structure including a distal end 16a, a distal intermediate point 16b, a proximal intermediate point 16c, and a proximal end 16d. The proximal end 16d is pivotally coupled to a pin 34 (FIG. 1A) extending between the side walls 14b of the second housing 14. The mounting member 16 extends from the channel 30 of the second housing 14 through a second opening 36 (FIG. 3) of the second housing 14 formed at the bottom of the front wall 14a. The mounting member 16 is also pivotally coupled to a first end 18a (FIG. 2) of the link member 18 at the proximal intermediate point 16c. The link member 18, which may include a front wall and two side walls extending therefrom, also includes a second end 18b (FIG. 2) which is connected to a moving end 22a (FIG. 2) of the biasing element 22. As shown in FIGS. 1A-1C, a shaft 38 passes through the second end 18b of the link member 18 and the ends of the shaft 38 extend into passages 40 formed on the side wall 14b of the second housing 14. The passages 40 can be open slots, as shown in the drawings or can take the form of enclosed channels formed by molding the second housing 14 to integrate the passages 40 or by welding a separate cover piece over a pre-existing slot in the second housing 14. The shaft 38 may be formed from a pin, a rivet or the like and in the case of an open slot, as shown, may be dimensioned such that the ends of the shaft 38 project out of the passages 40. The shaft 38 may include features allowing the shaft 38 to be secured to the second housing 14 by fastening means known in the art such as seal rings adapted to be inserted in an annular groove on the shaft 38.

The passages 40 define a predetermined path 42 that the ends of the shaft 38 travel along as the door 110 moves from a closed door position to an open door position. The predetermined path 42 may have a variety of forms and may be linear, curved, or a combination of the two. In the present embodiment, as shown in FIG. 1C, the predetermined path 42 can be substantially divided into an upper linear section 42a, a detent section 42b, and a lower linear section 42c. The detent position provides an intermediate and partially open position of the door which is commonly known as the “broil position.” In this embodiment, the shaft 38 is at the uppermost position in the predetermined path 42 when the door 110 is closed and is at the lowermost position when the door 110 is open.

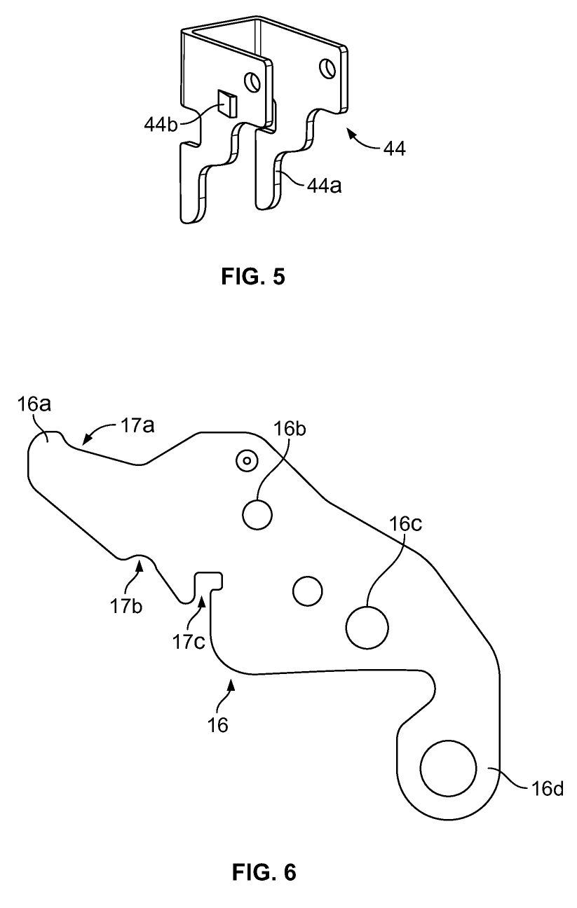

The delineation of the predetermined path 42 can also be supplemented by a cam bracket 44, shown in FIG. 5, which is inserted in the second housing 14 abutting the passages 40 within the channel 30. The geometry of a bottom part 44a of the cam bracket 44 matches an upper contour 40a (FIG. 3) of passages 40 such that the movement of the ends of the shaft 38 is further restricted by the cam bracket 44. The cam bracket 44 can be secured to the second housing 14 through a snap-in mechanism 44b and be further welded to the second housing 14.

In this embodiment, as shown in FIG. 2, the biasing element 22 is a compression spring with a fixed end 22b and a moving end 22a both of which provide a hook for attachment. The fixed end 22b is connected to a pin 46 (FIG. 1C) extending between the side walls 14b in an upper portion of the channel 30 while the moving end 22a biases the link member 18 upward such that the mounting member 16 is biased to rotate toward the second housing 14.

As shown in FIG. 2, the locking member 20 may include a front wall and side walls extending therefrom and includes a bottom end 20a that is pivotally coupled to the distal intermediate point 16b of the mounting member 16. The locking member 20 can be manually pivoted and is dimensioned such that an upper end 20b of the locking member 20, which has a recess 20c, can rest against an upper edge 36a (FIG. 3) of second opening 36 in a ready-for-mounting position or against the upper edge 26c of the first opening 26 in a mounted position. In the ready-for-mounting position, the locking member 20 maintains the mounting member 16 and the second housing 14 separated such that the distal end 16a of the mounting member 16 can be inserted into the first opening 26. Once the mounting member 16 is mounted to the first housing 26, the locking member 20 in the mounted position no longer intervenes with the pivoting of the hinge.

As shown in FIG. 6, the distal end 16a of the mounting member 16 includes a first abutting portion 17a, a second abutting portion 17b, and a slot 17c. The first abutting portion 17a may be formed from a pointed protrusion a tip of which is upwardly bent to form a recessed area at the top part of the protrusion that can receive the upper stop 28a. A bottom part of the protrusion includes a second abutting portion 17b that may be a concave recess that can receive the lower stop 28b. The bottom part of the protrusion also includes a slot 17c in which the lower edge 26d of the first opening 26 can fit into. The slot 17c may be straight or L-shaped as in this embodiment.

In order to mount the door 110 on the appliance 100, as shown in FIG. 1A, the mounting member 16 is inserted into the first opening 26 so that the lower edge 26d of the first opening 26 enters the slot 17c and the recessed area of the first abutting portion 17a wraps around the upper stop 28a. The recess of the second abutting portion 17b is configured to be supported by the lower stop 28b in the process. The weight of the door 110 maintains the lower edge 26d of the first opening 26 in the slot 17c, and the upper stop 28a and the lower stop 28b prevent the mounting member 16 from rotating backward and being dislodged from the first housing 12. Once the upper end 20b of the locking member 20 is pivoted to rest on the upper edge 26c of the first opening 26, the mounting process is complete and the door 110 can be manually adjusted to move back and forth from the closed position going through the partially open position to the fully open position.

The invention has been described with reference to the example embodiments described above. Modifications and alterations will occur to others upon a reading and understanding of this specification. Example embodiments incorporating one or more aspects of the invention are intended to include all such modifications and alterations.

What is claimed is:

1. A hinge assembly for a door enclosing a compartment, the assembly including:
a first housing configured to be mounted in the compartment and including a front wall and two adjacent side walls extending therefrom defining a channel, the front wall including an opening leading to the channel, the opening partially defined by a lower edge, an upper stop and a lower stop extending between the side walls in the channel, the upper stop located higher in the channel than the lower stop, the lower stop located closer to the front wall than the upper stop;
a second housing configured to be mounted in the door; and
a mounting member including a distal end and a proximal end, the proximal end of the mounting member pivotally coupled to the second housing, the distal end of the mounting member including a first abutting portion, a second abutting portion and a slot, the distal end of the mounting member configured to be inserted in the opening so that the first abutting portion engages the upper stop, the second abutting portion engages the lower stop and the slot engages the lower edge.

2. The hinge assembly of claim 1, wherein the distal end is a protrusion, the first abutting portion is formed at a top part of the protrusion, and the second abutting portion and the slot are formed at a bottom part of the protrusion.

3. The hinge assembly of claim 2, wherein the first abutting portion is formed by an upwardly bent tip and the second abutting portion is formed by a recess in the protrusion.

4. The hinge assembly of claim 1, wherein the opening is substantially elongate and includes a top portion that is rectangular and a bottom portion that the gradually tapers toward the lower edge.

5. The hinge assembly of claim 1, wherein the upper and lower stops have a round cross section.

6. A hinge assembly for a door enclosing a compartment, the assembly including:
a first housing configured to be mounted in a compartment, the first housing including a first opening;
a second housing configured to be mounted in a door, the second opening including a front wall and two adjacent side walls extending therefrom defining a channel, the second housing further including a second opening on the front wall;
a mounting member including a distal end, a proximal end, and a proximal intermediate point, the distal end configured to be inserted into the first opening and engage the first housing, and the mounting member pivotally coupled to the second housing at the proximal end and projecting out of the channel through the second opening; and
a link member including a first end and a second end, the first end pivotally coupled to the proximal intermediate point, a shaft through the second end configured to slide along a predetermined path between the side walls,
wherein the predetermined path is delineated by a pair of passages formed on each of the side walls.

7. The hinge assembly of claim 6, wherein the predetermined path is further delineated by a cam bracket inserted in the channel.

8. The hinge assembly of claim 6, further including a biasing element including a moving end and a fixed end, the moving end pivotally coupled to the second end of the link member, the fixed end coupled to the second housing, the biasing element biased to rotate the door and abut the enclosed structure.

9. The hinge assembly of claim 6, the mounting member further including a distal intermediate point, a locking member pivotally coupled to the distal intermediate point of the mounting member, the locking member having a coupled end and a free end, the locking member configured to lock the second housing about the mounting member in a detent position.

10. The hinge assembly of claim 6, wherein at least one of the front wall and the two side walls of the second housing member is reinforced by an elongate bead.
